(19) United States
(12) Patent Application Publication
(10) Pub. No.: US 2026/0350746 A1
(43) Pub. Date: Nov. 5, 2026

(54) TEMPORAL SUPERSAMPLING OF FRAMES

(71) Applicant: Microsoft Technology Licensing, LLC, Redmond, WA (US)

(72) Inventors: Yuxiao GUO, Beijing (CN); Guojun CHEN, Beijing (CN); Yue DONG, Beijing (CN); Xin TONG, Beijing (CN)

(73) Assignee: Microsoft Technology Licensing, LLC, Redmond, WA (US)

(21) Appl. No.: 19/105,118

(22) PCT Filed: Jul. 10, 2023
(86) PCT No.: PCT/US2023/027205

§ 371 Date: Feb. 20, 2025

(30) Foreign Application Priority Data
Aug. 23, 2022 (CN) 202211014245.0

(51) Int. Cl. G06T 3/4053; G06T 5/50; G06T 5/60; G06T 5/70; G06T 7/20; G06T 7/50; G06T 7/90; G06V 10/764; G06V 10/774

(52) U.S. Cl. CPC G06T 3/4053; G06T 5/50; G06T 5/60; G06T 5/70; G06T 7/20; G06T 7/50; G06T 7/90; G06V 10/764; G06V 10/774; G06T 2200/12; G06T 2207/20081; G06T 2207/20182; G06T 2207/20221

(57) ABSTRACT

According to implementations of the subject matter described herein, a solution for temporal supersampling of frames is provided. According to the solution, pixels of a target frame are classified into a plurality of pixel categories. A blending weight map for a reference frame of the target frame is determined at least based on a result of the classifying, the blending weight map indicating importance degrees of pixels of the reference frame in blending. The target frame is blended with the reference frame based on the blending weight map, to obtain a supersampled frame corresponding to the target frame. Through this solution, a more stable and accurate supersampling result can be achieved.

### BACKGROUND

Supersampling technique has been widely used in video rendering, especially three-dimensional (3D) rendering, to remove flickering in video frames and improve the resolution. The basic idea behind the supersampling technique is to use the pixel samples in previous frames to determine corresponding pixel samples in the current frame so as to achieve anti-aliasing and image quality improvement.

### SUMMARY

According to implementations of the subject matter described herein, a solution for temporal supersampling of frames is proposed. In this solution, pixels of a target frame are classified into a plurality of pixel categories. A blending weight map for a reference frame of the target frame is determined at least based on a result of the classifying, the blending weight map indicating importance degrees of pixels of the reference frame in blending. The target frame is blended with the reference frame based on the blending weight map, to obtain a supersampled frame corresponding to the target frame. Through this solution, a more stable and accurate supersampling result can be achieved.

The Summary is provided to introduce a selection of concepts in a simplified form that are further described below in the Detailed Description. The Summary is neither intended to identify key features or essential features of the subject matter described herein, nor is it intended to be used to limit the scope of the subject matter described herein.

### BRIEF DESCRIPTION OF THE DRAWINGS

FIG. 1 illustrates a block diagram of an example environment in which various implementations of the subject matter described herein can be implemented;

FIG. 2 illustrates a schematic block diagram of a supersampling system in accordance with some implementations of the subject matter described herein;

FIG. 3 illustrates a schematic block diagram of a supersampling system in accordance with some other implementations of the subject matter described herein;

FIG. 4 illustrates a flowchart of a process for temporal supersampling in accordance with some implementations of the subject matter described herein; and

FIG. 5 illustrates a schematic block diagram of an electronic device in which various implementations of the subject matter described herein can be implemented.

Throughout the drawings, the same or similar reference symbols refer to the same or similar elements.

### DETAILED DESCRIPTION OF EMBODIMENTS

The subject matter described herein will now be described with reference to some example implementations. It is to be understood that these implementations are described only for the purpose of illustration and help those skilled in the art to better understand and thus implement the subject matter described herein, without suggesting any limitations to the scope of the subject matter described herein.

As used herein, the term “includes” and its variants are to be read as open terms that mean “includes but is not limited to.” The term “based on” is to be read as “based at least in part on.” The terms “an implementation” and “one implementation” are to be read as “at least one implementation.” The term “another implementation” is to be read as “at least one other implementation.” The term “first,” “second,” and the like may refer to different or the same objects. Other definitions, either explicit or implicit, may be included below.

As used herein, the term “model” may learn an association between corresponding input and output from training data, and thus a corresponding output may be generated for a given input after the training. The generation of the model may be based on machine learning techniques.

Deep learning (DL) is one of machine learning algorithms that processes the input and provides the corresponding output using a plurality of layers of processing units. A neural network model is an example of a deep learning-based model. As used herein, “model” may also be referred to as “machine learning model”, “learning model”, “machine learning network” or “learning network”, which are used interchangeably herein.

Generally, machine learning may roughly include three stages, i.e., a training stage, a test stage, and an application stage (also referred to as an interference stage). In the training stage, a given model may be trained using a large scale of training data, with parameter values being iteratively updated until the model can obtain, from the training data, consistent interference that meets an expected target. Through the training, the model may be considered as being capable of learning the association between the input and the output (also referred to as an input-to-output mapping) from the training data. The parameter values of the trained model are determined. In the test stage, test inputs are applied to the trained model to test whether the model can provide correct outputs, so as to determine the performance of the model. In the interference stage, the model may be utilized to process an actual input based on the parameter values obtained from the training and to determine the corresponding output.

Supersampling is one of the techniques to remove image flickering and improve the resolution in video frames. For example, for video frames rendered in computer games or video frames generated in other computer programs, the image artifacts, such as aliasing or pixelated edges, may occur in rendering. The supersampling technique has been widely used to remove such image artifacts and can generate frames with higher resolution than the original frames.

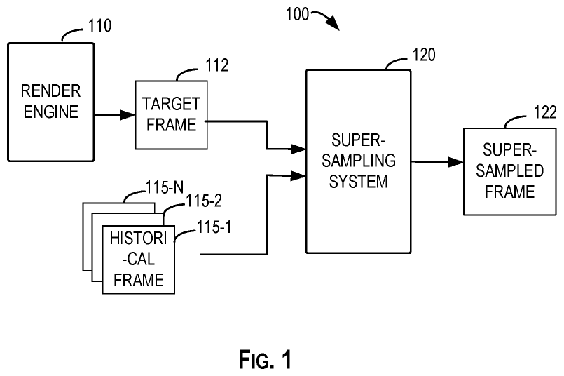

FIG. 1 illustrates a block diagram of an example environment 100 in which various implementations of the subject matter described herein can be implemented. In the environment of FIG. 1, a sequence of frames rendered by a render engine 110 are supersampled by a supersampling system 120 to obtain supersampled frames corresponding to the respective frames. As used herein, “frame” refers to a display unit in a video or frame sequence, which corresponds to an image, also called a video frame.

Specifically, for a current frame to be supersampled, referred to as a target frame 112, the supersampling system 120 is configured to blend the target frame 112 with one or more historical frames 115-1, 115-2, . . . , 115-N (collectively or separately referred to as “historical frames 115” for the purpose of discussion) preceding the target frame 112 to obtain a supersampled frame 122 corresponding to the target frame 112.

The supersampled frame 122 may have a higher resolution than the target frame 112. For example, the resolution of the target frame 112 may be 1920*1080 pixels, while the resolution of the supersampled frame 122 may be 3840*2160 pixels. In supersampling, the basic principle is that for a given pixel in the target frame 112, one or more corresponding historical pixels are determined from the historical frames 115, and the determined historical pixels are blended with the pixel in the target frame 112 to obtain a pixel of the supersampled frame.

Some current supersampling approaches utilize hand-crafted rules to determine one or more historical pixels corresponding to a pixel in each current frame for use, and blend the historical pixels with the pixel in the current frame to generate a supersampling result.

Although these approaches can obtain a high frame rate, it is still difficult to avoid the image artifacts, such as flickering and ghosting. Some other approaches propose to train a neural network in an end-to-end manner, which is used to directly map multiple consecutive frames to a supersampled frame for the current frame. However, those approaches are still difficult to avoid the flickering problem, and the amount of data to be processed by the neural network is large and thus the computational cost is large. In addition, such a neural network operates as a “black box”, and the loss function is difficult to be designed to achieve a good balance between the temporal stableness of the frame and the visual quality.

In the example implementation of the subject matter described herein, an improved solution for temporal supersampling of frames is proposed. This solution provides pixel classification-guided supersampling. Specifically, pixels of a target frame are classified into a plurality of pixel categories. A result of the classifying is used to determine a blending weight map for a reference frame of the target frame, which indicates importance degrees of pixels of the reference frame in blending. In this way, the target frame can be blended with the reference frame based on the blending weight map to obtain a supersampled frame corresponding to the target frame. According to the solution of the subject matter described herein, by distinguishing between different pixel categories in the target frame, the contributions of the reference frame in the supersampled frame of the target frame can be selectively determined, and the pixels of the reference frame can be blended with the pixels of the target frame in different blending ways. In this way, it is feasible to achieve a better balance between the temporal stableness and the image quality of the frame, and to produce a more stable and accurate supersampling result.

Some example implementations of the subject matter described herein will be described in more detail below with reference to the accompanying drawings.

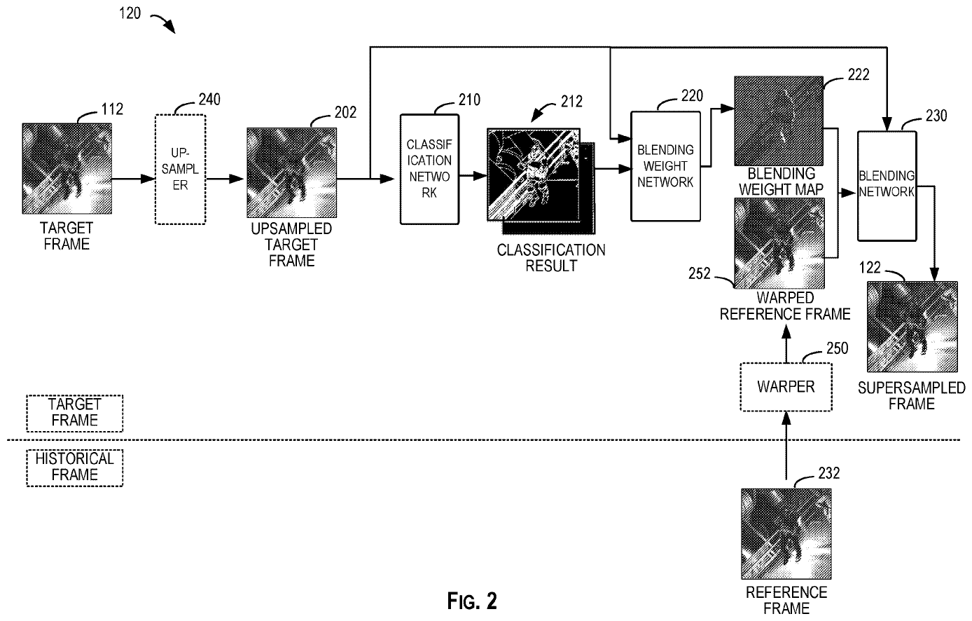

FIG. 2 illustrates a schematic block diagram of a supersampling system in accordance with some implementations of the subject matter described herein. The supersampling system of FIG. 2 may be, for example, implemented as the supersampling system 120 of FIG. 1. As shown in FIG. 2, the supersampling system 120 includes a classification network 210, a blending weight network 220, and a blending network 230. In some implementations, the supersampling system 200 also includes an upsampler 240 and a warper 250.

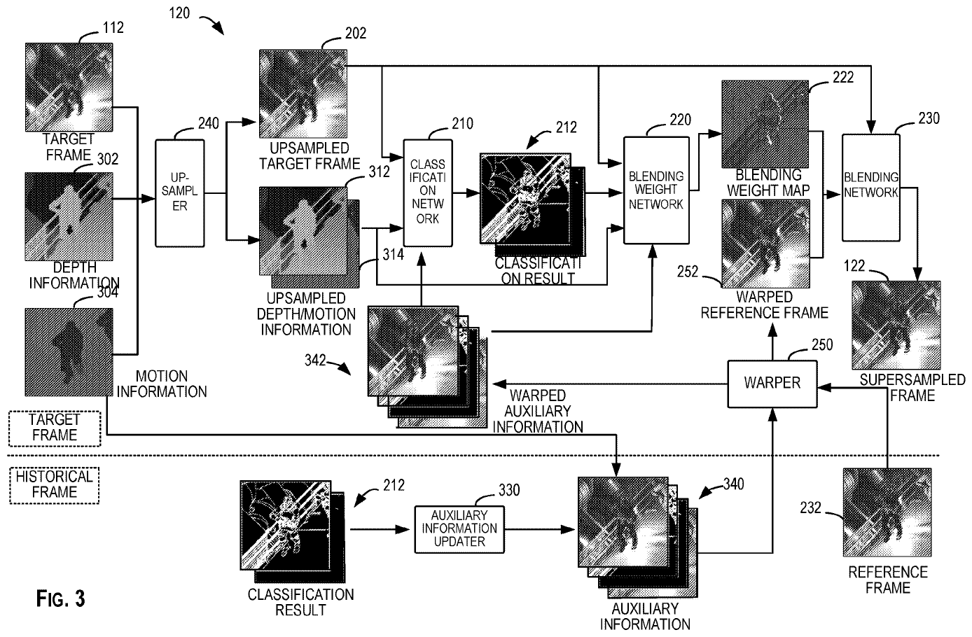

The various components in the supersampling system 120 may be implemented by hardware, software, firmware, and any combination thereof. Specific examples of some frames or information are shown in FIG. 2 and FIG. 3 below, but this is for illustrative purpose only and does not suggest any limitation to the specific implementation of the subject matter described herein.

In implementations of the subject matter described herein, the classification network 210 is configured to perform classification of pixels of the target frame 112. The target frame 112 may be a current frame of a video sequence to be processed, for example, from the render engine 110. The resolution of the target frame 112 may be the resolution as rendered by the render engine 110. In some implementations, the pixels of the target frame 112 may indicate color information after the rendering by the render engine 110.

In some implementations, to facilitate subsequent processing, the target frame 112 is upsampled by the upsampler 240 to be an upsampled target frame 202 for pixel classification by the classification network 210. The upsampled target frame 202 may have the same resolution as the supersampled frame 122 to be generated. For example, if the resolution of the target frame 112 is 1920*1080 and the resolution of the supersampled frame 122 is 3840*2160 pixels, the resolution of the target frame 112 can be increased by two times by the upsampling. Different from the supersampling technique, the upsampling is to improve the resolution by interpolating the pixels of the target frame 112. The target frame 112 may be upsampled using various interpolation methods, such as bi-cubic interpolation.

The classification network 210 may output a classification result 212 of the target frame 112, which indicates the classification of the pixels of the target frame 112 (the pixels of the upsampled target frame 202) in a plurality of pixel categories. The blending weight network 220 is configured to determine a blending weight map 222 for the reference frame 232 of the target frame 112 at least based on the classification result 212.

In implementations of the subject matter described herein, different types of pixels are considered as having different dependencies on historical pixel values for supersampling, and thus different blending methods need to be applied. In particular, pixels that may cause image ghosting and image aliasing need to be treated differently. The image artifacts in a frame may be caused by some pixels that large shading variations or visibility changes, and some pixels that cover high frequency content and are thus insufficiently sampled. The two types of pixels usually exhibit similar pixel value changes (e.g., brightness changes) between frames, but need to be handled in totally different way during supersampling. For the pixels in the category of image ghosting, corresponding pixels in the historical frames make little contribution to the current frame, and thus the pixels of the historical frames need to be selectively considered. For the pixels in the category of image aliasing, corresponding pixels of historical frames can be accumulated to resolve the aliasing problem in the current frame. If these pixels are not distinguished from each other, the supersampling result will exhibit “ghosting” artifacts for the first category of pixels and flickering for the second category of pixels. In addition, the degrees of dependence on the historical pixels are also different for different reasons in introducing ghosting or aliasing.

In implementations of the subject matter described herein, two tasks are introduced in the supersampling process, namely, pixel classification and blending weight determination.

The two tasks are implemented by the classification network 210 and the blending weight network 220, respectively. The result of the pixel classification is used to guide the determination of the blending weights.

In some implementations, the pixels of the target frame 112 may be classified in terms of ghosting pixels and/or aliasing pixels. Specifically, the pixels of the target frame 112 (or the upsampled target frame 202) may be divided into an aliasing pixel category or categories and a ghosting pixel category or categories. In some implementations, considering that a pixel may be both an aliasing pixel and a ghosting pixel (e.g., high-frequency shading variations), the classification network 210 may be configured to perform two classification tasks, i.e., classification of image aliasing and classification of image ghosting, so as to determine a probability that a pixel of the target frame 112 (or of the upsampled target frame 202) belongs to the aliasing pixel category and/or the ghosting pixel category.

In some implementations, at least one pixel category related to the aliasing pixels may be predefined, for example, including an aliasing pixel category and a non-aliasing pixel category, and at least one pixel category related to the ghosting pixels may be predefined, including a ghosting pixel category and a non-ghosting pixel category. For a given pixel of the target frame 112 or the upsampled target frame 202, the classification result 212 indicates a probability that the pixel belongs to the at least one pixel category related to the aliasing pixels, and a probability that the pixel belongs to the at least one pixel category related to the ghosting pixels.

In some implementations, in performing the pixel classification based on image aliasing, the aliasing pixel category may be further subdivided according to the reasons causing the aliasing. Aliasing pixels usually occur in a region of a frame with high-frequency spatial variations. The reasons causing the aliasing pixels may include geometry boundaries, high-frequency pixel normal and texture and so on. For the aliasing pixels, more historical valid pixels are needed to correctly reconstruct the pixel values of the aliasing pixels. The categories related to the aliasing pixels may at least include the following three categories: a geometry aliasing pixel category, a texture aliasing pixel category, and a non-aliasing pixel category. Different aliasing pixel categories may need to accumulate historical pixels in different strategies for blending with the pixels of the current frame.

In some implementations, in performing the pixel classification based on image ghosting, the ghosting pixel category may be further subdivided according to the cause of the ghosting. The categories related to the ghosting pixels may include at least the following three categories: a visibility induced ghosting pixel category, a shadow ghosting pixel category, and a non-ghosting pixel category.

Visibility induced ghosting, also known as visibility induced pixel value change, means that the visibility of the object presented in the target frame is occluded, for example, the motion vector of the pixel in the target frame is pointing to a different object due to occlusion. Since the visibility changes, the information of corresponding pixels in the historical frames will be untrustworthy for the pixels of the current frame. Shadow ghosting, also known as shading induced pixel value change, refers to the ghosting caused by the shading variations. For the pixels related to such artifacts, the corresponding pixels in the historical frames are useful, but their contributions need to be calculated based on the shading variations.

In the case of parallel classification based on the image aliasing and image ghosting, the classification network 210 may output at least six values for a pixel of the target frame 112 (or of the upsampled target frame 202), indicating the respective probabilities that the pixel belongs to the above six pixel categories. Some pixels may have higher probabilities in certain categories related to the aliasing pixels and certain categories related to the ghosting pixels, while some other pixels may have higher probabilities only in certain categories of aliasing pixels or ghosting pixels.

In some implementations, the classification network 210 and/or the blending weight network 220 may implement their respective functionalities based on machine learning techniques. For example, the classification network 210 may include a classification model trained based on a machine learning model, and the blending weight network 220 may include a blending weight model trained based on a machine learning model. In some implementations, when considering the classification of aliasing pixels and ghosting pixels, the classification model may include two classifiers, which are respectively used to perform the classification related to the aliasing pixels and the classification related to the ghosting pixels. The input of the classification model (or each classifier) includes at least the target frame 112 or the upsampled target frame 202, and the output includes the classification result 212 or at least a part thereof (in the example of two classifiers). The input of the blending weight model includes at least the classification result 212 and the target frame 112 or the upsampled target frame 202, and the output includes the blending weight map 222.

The models used by the classification network 210 and the blending weight network 220 may be configured based on various suitable model structures. As an example, the classification model may be implemented using a convolutional structure and have an encoder-decoder structure, where the encoder may extract features of the model input and the decoder may determine the classification result 212 based on the extracted features. In some examples, the classification result output by the classification model may have a lower resolution than the upsampled target frame 202, such as the same resolution as the target frame 112. For example, the classification result indicates the classification result of respective pixels in the target frame 112 in the plurality of pixel categories. In this example, the classification result may be upsampled (e.g., through bilinear up sampling), to obtain the classification result 212 having the same resolution as the upsampled target frame 202. As a result, the classification result 212 can indicate the classification of respective pixels in the upsampled target frame 202.

As an example, the blending weight model may be implemented based on a multi-layer perceptron (MLP). In some implementations, a plurality of consecutive pixel-wise MLPs may be used as a backbone network to process the model input (e.g., the classification result 212 and the upsampled target frame 202). A pixel-wise MLP may include a plurality of pixel-wise fully connected (FC) layers. In this way, a corresponding blending weight can be determined for each pixel in the pixel space of the same size as the upsampled target frame 202. The activation function of MLP can be selected as required, for example, as the ReLU function, Sigmoid function, or the like. The last layer of the MLP may be selected as an activation function that can output a blending weight in [0, 1], such as the Sigmoid function.

Of course, some examples of the classification model and the blending weight model are provided here. Different models can be configured according to actual application requirements as long as the functionalities described here can be realized. The training data of the models in the classification network 210 and the blending weight network 220 may be determined according to their respective model inputs and outputs. The training of the models will be discussed in more detail below.

In implementations of the subject matter described herein, different tasks in the supersampling are implemented by different machine learning models. Compared with some end-to-end trained supersampling models, the classification network 210 and the blending weight network 220 can have their own objectives to be trained respectively. Such two-step design makes it possible to complete the corresponding functionalities (e.g., the classification and weight determination) by using higher performance and more compact models for each step, thereby reducing the calculation overhead and memory I/O overhead of the whole system. In addition, by using different classifiers to perform the classification for aliasing pixels and ghosting pixels, these classifiers can be optimized with different training objectives and loss functions to improve classification accuracy. In this way, a good balance between further temporal stableness and image quality of the frames can be achieved.

The blending weight map 222 output by the blending weight 220 indicates the importance degrees of pixels for a reference frame 232 of the target frame 112 in its blending with the target frame 112. In some implementations, the reference frame 232 for blending may include a historical supersampled frame corresponding to a historical frame 115 preceding the target frame 112, for example, a historical supersampled frame corresponding to a last frame preceding the target frame 112. The historical supersampled frame may also be an output from supersampling of the historical frame 115 by the supersampling system 120. In this way, the reference frame 232 may be considered to have accumulated information of historical pixels of the historical frames. The blending weight map 222 may have the same size as the reference frame 232 and indicate the weights of the corresponding historical pixels of the reference frame 232 for blending with respect to the current target frame 112.

In some implementations, the higher the weight in the blending weight map 222, the higher the contribution of the corresponding pixel of the reference frame 232 to the target frame 112. Of course, in some implementations, as required, the blending weight map 222 may also be configured in the opposite manner, for example, a higher weight indicates that the current pixel of the target frame 112 has more contribution to the blended supersampled frame 122, while the reference frame 232 has lower contribution.

In some implementations, the reference frame 232 is warped by the warper 250 before the blending, to map respective pixels of the reference frame 232 into the frame space of the target frame 112 or the upsampled target frame 202. Thus, the pixels in a warped reference frame 252 are spatially aligned with the pixels of the upsampled target frame 202, respectively. Then, a pixel of the reference frame 232 corresponding to the target frame 112 or the upsampled target frame 202 refers to a pixel at the same spatial position after the reference frame 232 is warped into the frame space of the target frame 112.

The blending network 230 is configured to blend the target frame 112 with the reference frame 232 based on the blending weight map 222, to obtain the supersampled frame 122 corresponding to the target frame 112. The supersampled frame 122 not only has a higher resolution, but also can achieve anti-aliasing and remove image flickering in consecutive frames, thus having better image quality. Specifically, in the blending, the blending network 230 uses the blending weight map 222 to blend the upsampled target frame 202 with the warped reference frame 252. The blending weight map 222 may be used to weight the warped reference frame 252 (if the weights directly indicate the importance degrees of the pixels of the reference frame) or to weight the upsampled target frame 202 (if the weights directly indicate the importance degrees of the pixels of the upsampled target frame 202).

In implementations of the subject matter described herein, with the guidance of the pixel classification, information of historical frames can be blended in different ways for different types of pixels during the supersampling, so that temporal supersampling results with higher visual quality can be obtained, image aliasing can be effectively removed, and flickering artifacts will be eliminated.

In some implementations, in addition to the target frame itself, additional auxiliary information may be utilized to assist in the pixel classification and/or the determination of the blending weights. FIG. 3 shows a schematic block diagram of a supersampling system 120 in accordance with some other implementations of the subject matter described herein.

In the example implementation of FIG. 3, depth information 302 and/or motion information 304 of the target frame 112 may be taken into account in one or more stages of the pixel classification and the blending weight determination. Alternatively, or in addition, in some implementations, auxiliary information 340 related to one or more historical frames may be taken into account. In FIG. 3 and the following description, it is shown that all the three types of information are taken into account by the classification network 210 and the blending weight network 220 for the purpose of explanation. However, it is to be understood that in other implementations, one or more types of the information may be omitted in actual applications.

The depth information 302 indicates the depth in the target frame 112, for example, the distance between an object presented in the target frame 112 and the (hypothetical) photographing camera. The motion information 304 may indicate a motion vector of an object in the target frame 112. The depth information 302 and the motion information 304 may be provided by the render engine 110. In some implementations, for example, in rendering of a game video, the depth information 302 and the motion information 304 are generally available as metadata of the video. In other implementations, one or both of the depth information 302 and the motion information 304 may also be obtained in other ways or may be used only when either one of them is available.

The depth information 302 and the motion information 304 may have the same resolution as the target frame 112. In some implementations, the depth information 302 and the motion information 304 may be upsampled via the upsampler 240 to obtain upsampled depth information 312 and upsampled motion information 314. The upsampled depth information 312 and upsampled motion information 314 may have the same resolution as the upsampled target frame 202. In some implementations, in upsampling of the motion information 304, a motion vector corresponding to one pixel in the target frame 112 may be expanded into motion vectors of a plurality of pixels based on the depth information (in the example of supersampling from 1920*1080 to 3840*2160, from one pixel to two pixels), to obtain the upsampled motion information 314.

The upsampled depth information 312 and upsampled motion information 314 may be provided as inputs to the classification model in the classification network 210 for jointly determining the classification result of the pixels of the upsampled target frame 202.

Alternatively, or in addition, the upsampled depth information 312 and upsampled motion information 314 are provided as inputs to the blending weight model in the blending weight network 220 for jointly determining the blending weight map 222.

In some implementations, the auxiliary information 340 related to one or more historical frames may indicate statistical information in the historical frames. The auxiliary information 340 may be buffered in an auxiliary buffer and may be updated frame by frame.

For example, the motion information 304 and/or the classification result 212 of the current target frame 112 may also be used by an auxiliary information updater 330 to update the auxiliary information 340. In some examples, the auxiliary information 340 useful for the pixel classification and/or the blending weight determination may be determined based on the historical frames.

In some implementations, in the auxiliary information 340, the number of valid pixels in historical pixels of the historical frames may be counted. For example, an valid pixel counter may be set to record the number. Here, a valid pixel refers to a historical pixel in a historical frame that is valid or useful for a target pixel in the target frame 112. This is because the historical pixels corresponding to the visibility induced ghosting pixels are useless. In some implementations, the number of valid pixels may be determined based on the classification result 212 of the current target frame 112. If the classification result 212 indicates that a certain pixel in the upsampled target frame 202 is classified in the visibility induced ghosting pixel category (e.g., the probability corresponding to this category is higher than the probabilities corresponding to other categories related to the ghosting pixels), the number of valid pixels is reset to 0. This is because the historical pixels are no longer valid for the ghosting pixels introduced for the current visibility. If the classification result 212 indicates that a certain pixel in the upsampled target frame 202 is not classified as in the visibility induced ghosting pixel category, the number of valid pixels is accumulated by 1. In some implementations, the reciprocal of the number of valid pixels may be provided as input to the classification network 210 and/or the blending weight network 220.

In some implementations, for target pixels in the current target frame 112, a color change range of the valid pixels in the historical pixels of the historical frames and the target pixels can be counted for the auxiliary information 340. The color change range can be accumulated by the color changes of a specific pixel point in a plurality of consecutive frames. In some implementations, the color change range may indicate a maximum value and a minimum value corresponding to each color channel. By counting the color changes in a plurality of historical frames, it can help to distinguish between aliasing and shading variations. In some implementations, a historical color range counter may be set to record the color change ranges of the valid pixels. If the classification result 212 indicates that a pixel in the upsampled target frame 202 is classified in the visibility induced ghosting pixel category, the historical color range counter is reset to the color value of the pixel in the upsampled target frame 202. This is because the historical pixels are no longer valid for the ghosting pixels introduced for the current visibility. For the target frame 112, the color change ranges counted from the historical frames may first be warped into the frame space of the target frame 112. However, the color values of each pixel in the upsampled target frame 202 may also be used to update information of the color change ranges corresponding to the warped pixels, so as to reflect the color change ranges of the valid pixels of the historical pixels and the target pixels.

In some implementations, for the target pixels in the current target frame 112, a depth difference between the target pixels and the historical pixels in the historical frames may be counted in the auxiliary information 340. For example, pixel-wise depth differences between the depth information corresponding to the historical warped reference frame (which is warped into the frame space of the target frame) and the upsampled depth information 312 may be determined.

In some implementations, for the target pixels in the current target frame 112, a classification result of historical pixels in the plurality of predetermined pixel categories may be counted in the auxiliary information 340. For example, the classification results of the previous frames of the target frame 112 may be recorded. In some examples, a classification result may include the probability that each pixel of a historical frame (or the upsampled historical frame) belongs to the plurality of pixel categories.

In some implementations, the auxiliary information 340 may be in the space corresponding to the historical frame. In order to facilitate the pixel classification and/or blending weight determination applied to the target frame 112, the auxiliary information 340 may be warped to the frame space corresponding to the target frame 112 or the upsampled target frame 202 via the warper 250. Thus, the warped auxiliary information 342 may indicate various kinds of auxiliary information of the target pixel in the historical pixel corresponding to the target frame 112 or the upsampled target frame 202.

By taken into account different types of auxiliary information, depth information, motion information, and the like, the pixel classification and blending weight determination can be conducted in a more accurate way. Since the auxiliary information 340 has been blended with enough information in the historical frames, the classification network 210 and the blending weight network 220 may not need to directly process the historical frames. In such implementations, instead of utilizing all historical frames as model inputs, the statistical information extracted from the historical frames is used as auxiliary information to facilitate the pixel classification and blending weight determination. In this way, the long-term historical information can be utilized more efficiently to support long-term rendering applications. In addition, due to the less amount of model inputs, the classification model and the blending weight model can also be designed as lightweight model with low complexity in model processing and thus low computational overhead and memory overhead.

In some implementations, the blending weight network 220 may utilize the auxiliary information except the depth difference to determine the blending weights. In addition, different from the classification network 210, the blending weight network 220 may directly utilize the classification result 212 for the current target frame 112 without utilizing the classification results of the historical frames.

In some examples as mentioned above, the classification network 210 may implement the pixel classification using a machine learning model, and the blending weight network 220 may also implement determination of blending weights using a machine learning model.

These models need to be trained with training data. In some implementations, high-resolution frames with a same resolution as the supersampled frames to be output may be rendered as sample frames using a rendering algorithm. In addition, labeling information corresponding to a sequence of sample frames is also determined to indicate classification results of pixels of the sample frames in the plurality of predetermined pixel categories and blending weight maps. In some implementations, since the classification results and the blending weights need to be labelled in a pixel-wise way, the classification results can be determined based on a series of predetermined rules, and the corresponding blending weights can be determined for the pixels in different pixel categories.

It is discussed blow how to define a classification result in a sample frame. In some implementations, the determination of the classification result may be based on depth information and/or motion information of the sample frame.

As mentioned above, the categories of pixels can be divided from two terms of image aliasing and image ghosting. It is assumed that for each sample frame used for training, an aliasing pixel map A, a geometry aliasing pixel map A_{G}, a texture aliasing pixel map A_{T}, a ghosting pixel map R, a visibility induced ghosting pixel map R_{G}, and a shadow ghosting pixel map R_{S} can be determined. These maps each have the same resolution as the sample frame to indicate whether each pixel belongs to the corresponding pixel category. Pixels that do not belong to the aliasing pixels and the ghosting pixels can be determined from the aliasing pixel map A and the ghosting pixel map R, respectively.

In terms of image ghosting, a ghosting pixel refers to the pixel whose historical pixels are no longer valid, and thus if the historical pixels are used incorrectly, it will introduce the ghosting. As mentioned above, the categories of ghosting pixels may at least include: the visibility introduced ghosting pixel category, the shadow ghosting pixel category, and the non-ghosting pixel category.

For a visibility introducing ghosting pixel, in order to compensate the motion of the object, for a pixel (x,y) of the current f^{-th} frame, its frame space position in the (f−1)^{-th} frame can be calculated, and the label information R_{G} of the visibility introducing ghosting can be determined based on the depth difference. However, to the improve robustness, the velocity difference is also taken into account because different objects may have different view space velocity. In some implementations, if the depth difference between the pixel (x,y) of the current f^{-th} frame and the pixel at the corresponding position of the (f−1)^{-th} frame exceeds a certain depth threshold, and the velocity difference also exceeds a certain velocity threshold, then it can be determined that the pixel (x,y) of the f^{-th} frame is a visibility induced ghosting pixel. The decision criteria for the visibility induced ghosting pixels are represented as follows:

$$\frac{( {D}_{max} ( {𝒲}_{f \to f - 1} ( x , y ) , f - 1 ) - {D}_{max} ( x , y , f - 1 ) )}{{D}_{max} ( {𝒲}_{f \to f - 1} ( x , y ) , f - 1 )} > {T}_{D}^{G} \qquad ( 1 )$$

$${‖ V ( x , y , f ) - V ( {𝒲}_{f \to f - 1} ( x , y ) , f - 1 ) ‖}_{2}^{2} > {T}_{V}^{G} \qquad ( 2 )$$

where

$${T}_{D}^{G}$$

represents a depth threshold;

$${T}_{V}^{G}$$

represents a velocity threshold; [symbol] refers to the corresponding frame space position of the pixel (x,y) of the f^{-th} frame after warping it to the (f−1)^{-th} frame; Dₘₐₓ represents the maximum depth within the depth range of the pixels of the corresponding frame; V/represents the velocity of the pixel of the corresponding frame; ∥

$${‖}_{2}^{2}$$

represents the L2 norm of the square of the velocity difference. In the above example, it is assumed that the depth information D indicates the reversed depth, so that a larger reversed-depth value indicates that the object is closer to the camera.

In some cases, the above criteria may be unstable in the object boundary where the depth within a pixel at the object boundary changes in a large range among consecutive frames. As a result, to avoid the error caused by the depth change at the boundary, when some conditions are satisfied, the label of the visibility induced ghosting can be dilated from the pixel (x,y) of the f^{-th} frame to the neighboring pixels (x′, y′) within the frame; that is, the neighboring pixels are also labelled as the visibility induced ghosting pixels. In some implementations, if the depth difference between the pixel (x,y) of the current f^{-th} frame and a neighboring pixel (x′, y′) exceeds a certain depth threshold, and the velocity difference also exceeds a certain velocity threshold, the neighboring pixel may also be determined as a visibility induced ghosting pixel, which can be represented as follows:

$$\frac{( {D}_{max} ( x , y , f ) - {D}_{max} ( {x}^{′} , {y}^{′} , f ) )}{{D}_{max} ( x , y , f )} > {T}_{D}^{G} \qquad ( 3 )$$

$${‖ V ( x , y , f ) - V ( {x}^{′} , {y}^{′} , f ) ‖}_{2}^{2} > {T}_{V}^{G} \qquad ( 4 )$$

Shadow ghosting refers to the ghosting caused by the shading change. One way to detect rapid shading change is comparing the pixel color. In some implementations, if the difference between the pixel color in the current f^{-th} frame and the pixel color in the reference frame is greater than a predetermined color threshold

$${T}_{I}^{G} ,$$

the pixel in the current frame can be considered as a shadow ghosting pixel R_{S}. The decision criteria for the shadow ghosting pixels can be represented as follows:

$$( {I}_{max} ( x , y , f ) - {I}_{max} ( {𝒲}_{f \to f - 1} ( x , y ) , f - 1 ) ) > {T}_{I}^{G} \qquad ( 5 )$$

where [symbol] refers to the corresponding frame space position of the pixel (x,y) of the f^{-th} frame after warping it to the (f−1)^{-th} frame; Iₘₐₓ represents the maximum color value in the pixel (x,y) of the corresponding frame (the f^{-th} frame or the (f−1)^{-th} frame).

In some cases, the spatially high-frequency textures, normal maps, and the like appearing in the frame may make the above decision criteria for shadow ghosting pixels inaccurate, where a single color value Iₘₐₓ cannot represent all the samples within this pixel. Therefore, in some implementations, to further filter out pixel unstable color changes caused by the spatially high-frequency textures, it is also to compare the overlap degree of the pixel color in the f^{-th} frame and the pixel color in the (f−1)^{-th} frame, e.g., the intersection over union (IOU). IOU is used to measure the ratio of intersection and union of two bounding boxes, indicating the overlapping degree of the two bounding boxes. For example, if the overlapping degree is less than a predetermined color overlap degree threshold, the pixel in the current f^{-th} frame may be considered as a shadow ghosting pixel R_{S}. Accordingly, the decision criteria for the shadow ghosting pixels can be represented as follows:

$$IoU ( I ( x , y , f ) , I ( {𝒲}_{f \to f - 1} ( x , y ) , f - 1 ) ) < {T}_{IoU}^{G} \qquad ( 6 )$$

where

$${T}_{IoU}^{G}$$

represents a color overlap threshold; I represents the color range of all the samples in a corresponding pixel of the corresponding frame; IoU( ) represents the IoU of the color boundary box of the pixel (x,y) in the f^{-th} frame and the color boundary box of the corresponding pixel in the (f−1)^{-th} frame. If the pixel has spatially smooth shading, the color bounding box is small, and therefore the IoU is small. If the pixel have large spatial variance, the color bounding box is large and the IoU is large, then the pixel will be discarded.

In some implementations, in order to avoid small regions being marked as shadow ghosting (which are usually prone to flickering), morphological opening (erosion followed by dilation) can be applied to the label maps of shadow ghosting. The erosion operation refers to eroding the highlighted region in the image, so that the highlighted region is decreased, and the resulting image has a smaller highlighted area than the original image. In operation, the means adopted is to replace the neighboring region with the minimum value to reduce the highlighted area. The dilation operation refers to dilating the highlighted area in the image to expand the highlighted region, and the resulting image has a larger highlighted area than the original image. In operation, the means adopted is to replace the neighboring area with the maximum value to increase the highlighted areas.

In terms of image aliasing, an aliasing pixel refers to a pixel in high-frequency spatial variation regions. As mentioned above, for pixel classification based on the image aliasing, the categories related to the aliasing pixels can at least include: the geometry aliasing pixel category, the texture aliasing pixel category, and the non-aliasing pixel category.

In some implementations, the aliasing pixels in the sample frame may be determined based on the depth, normal, color changes of the pixels, and the like. In some implementations, if the depth change degree of the pixel (x,y) of the current f^{-th} frame is greater than a certain depth threshold, the pixel (x,y) can be considered as an aliasing pixel. In some implementations, a depth range in a plurality of consecutive sample frames may be observed for each pixel in the frame space, for example, represented by a maximum depth value and a minimum depth value. In the current sample frame, the depth change degree of a certain pixel may be determined based on the difference between the recorded maximum depth value and the recorded minimum depth value. The decision criteria based on the depth change degree may be represented as follows:

$$\frac{( {D}_{max} ( x , y , f ) - {D}_{min} ( x , y , f ) )}{{D}_{max} ( x , y , f )} > {T}_{D}^{A} \qquad ( 7 )$$

where

$${T}_{D}^{A}$$

represents a depth threshold, Dₘₐₓ represents the maximum depth within the depth range in the pixel (x,y) of the f^{-th} frame, Dₘᵢₙ represents the minimum depth within the depth range in the pixel (x,y) of the f^{-th} frame. It is to be understood that, in addition to the above expression, the depth change within the pixel can be measured in other ways, and whether the pixel is an aliasing pixel can be determined based on the comparison of the depth change and the corresponding threshold.

In some implementations, alternatively, or in addition, if the normal change degree of the pixel (x,y) of the current f^{-th} frame is greater than a certain normal threshold, the pixel (x,y) can be considered as an aliasing pixel. For example, in the set of all normal samples [symbol] (x,y) within the pixel (x,y), it can be determined whether the maximum difference between each normal sample and a specific normal sample is greater than the normal threshold. The decision criterion based on the normal change degree can be represented as follows:

$${max}_{i ∈ ℕ ( x , y )} {‖ {N}_{0} ( x , y , f ) - {N}_{i} ( x , y , f ) ‖}_{1} > {T}_{N}^{A} \qquad ( 8 )$$

where

$${T}_{N}^{A}$$

represents the normal threshold; N₀(x,y,f) represents a specific normal sample within the set of normal samples [symbol] (x,y), such as the first sample; Nᵢ(x,y,f) represents the i^{-th} normal sample in the set of normal samples [symbol] (x,y), ∥ ∥₁ represents the L1 norm of the normal difference. It is to be understood that in addition to the above expression, in other implementations, it is also possible to calculate the difference between any pair of normal samples in the normal sample set and determine whether the maximum normal difference is greater than a predetermined threshold. In addition, the differences between normal samples within a pixel may also be measured in other ways, and whether the pixel is an aliasing pixel may be determined based on a comparison of the determined differences with a threshold.

In some implementations, alternatively, or in addition, if the color change degree of the pixel (x,y) of the current f^{-th} frame is greater than a certain color threshold, for example, the ratio of the difference between the maximum color value and the minimum color value of the sample within the pixel to the maximum color value is greater than a certain color threshold, the pixel (x,y) can be considered as an aliasing pixel. The decision criteria based on the degree of color change may be represented as follows:

$${max}_{r , g , b} \vert \frac{( {I}_{max} ( x , y , f ) - {I}_{min} ( x , y , f ) )}{{I}_{max} ( x , y , f )} \vert > {T}_{I}^{A} \qquad ( 9 )$$

where

$${T}_{I}^{A}$$

represents a color threshold, Iₘₐₓ represents the maximum color value in the sample of the pixel (x,y) of the f^{-th} frame, Iₘᵢₙ represents the minimum color value in the samples of the pixel (x,y) of the f^{-th} frame. It is to be understood that in addition to the above equation, the color change within the pixel can be measured in other ways, and whether the pixel is an aliasing pixel can be determined based on the comparison of the color change and the corresponding threshold.

In some implementations, the aliasing pixels may also be subdivided into the geometry aliasing pixel category and texture aliasing pixel category based on the above Equations (7), (8) and (9). In some implementations, the pixels in the f^{-th} frame satisfying the above Equations (7) or (8) may be labelled as geometry aliasing pixels, to obtain the geometry aliasing pixel map A_{g} corresponding to the f^{-th} frame. In addition, the pixels in the f^{-th} frame satisfying any one of the above Equations (7), (8) and (9) may also be labelled as aliasing pixels, to obtain the complete aliasing pixel map A corresponding to the f^{-th} frame. Thus, the texture aliasing pixel map A_{T} corresponding to the f^{-th} frame can be determined by subtracting the geometry aliasing pixel map A_{T} from the complete aliasing pixel map A.

In some implementations, since the labeling information of the shadow ghosting pixels is calculated based on the motion information, this means that the visible points are marked.

When there is a visibility change (for example, there is visibility introduced ghosting), the motion vector will no longer be valid, so the visibility introduced ghosting should not be marked as shadow ghosting. In some cases, the labelling of the shadow ghosting may also be affected by image aliasing. For example, when the content of a frame has strong aliasing, the shadow ghosting label may become unstable. Therefore, if a pixel in a frame is marked as visibility induced ghosting or aliasing, the pixel may not be marked as a shadow ghosting pixel.

After the pixel categories are marked, in some implementations, the blending weights corresponding to the pixels of different categories can be set as pre-set values, so as to obtain the ground-truth blending weight map for training. In some implementations, for a certain sample frame, the blending weights corresponding to the pixels labelled as the ghosting pixel categories (including the visibility induced ghosting pixel category and the shadow ghosting pixel category) may be set to 1 (indicating that the pixels completely depend on the current sample frame) or 0 (indicating that it does not depend on the historical pixel). The value of 0 or 1 may be determined based on the definition of the blending weights in the blending weight map. In some implementations, the blending weights of the remaining pixels in the sample frame may be set to the reciprocal of the number of valid pixels in the historical frames determined in the auxiliary information, that is, the larger the number of valid pixels is, the lower the contributions of the pixels of the current sample frame are, and the higher the contributions of the historical pixels are.

Alternatively, the blending weights of the remaining pixels in the sample frame may be set to 1 minus the reciprocal of the number of valid pixels, that is, the larger the number of valid pixels in the historical frames is, the higher the contributions of the historical pixels are. These two weight setting approaches are also determined depending on the definitions of the blending weights in the blending weight map.

In the case that the training data is determined, during the training, the classification model used by the classification network 210 and the blending weight model used by the blending weight network 220 may be separately trained. For example, the classification model may be trained first, and then the blending weight model may be trained with the classification model fixed. Since the supersampled frame based on the blending weight map will be used as a historical frame, which will affect the next classification, the two models can be trained iteratively.

In some implementations, in the training process, for the classification model used by the classification network 210, a cross-entropy loss function may be applied to each pixel of the frame for model training. In some implementations, since there are always fewer ghosting pixels and aliasing pixels in each frame, the cross-entropy loss may be rebalanced based on the ratio of the total number of ghosting pixels and aliasing pixels to the total number of pixels in the frame. In some implementations, if some pixels in the aliasing pixel regions are labelled as ghosting pixels (i.e., false positive samples of ghosting pixels), the wrongly labelled ghosting pixels will cause significant flickering for those aliasing pixel regions. In order to enable the classification model to enhance the temporal stableness in this case, the same weight as the ghosting pixels can be used to amplify the loss calculated for this case.

Based on different pixel classification, the loss function for the blending weight model may include at least the following three parts: a loss based on the geometry aliasing pixels, where the geometry aliasing pixels are correctly divided by the classification model, and the L1 loss can be directly calculated; no loss may be applied to the aliasing pixels that cannot be correctly classified or labelled as false positive samples; a regular L1 image reconstruction loss for the remaining pixels.

It has been discussed above some approaches for determining the training data of the models and some examples of the model training process. In other implementations, the training data of the classification model and the blending weight model may be obtained in other ways according to the actual applications, and the models may be trained in any other appropriate manners. The implementations of the subject matter described herein are not limited in this regard.

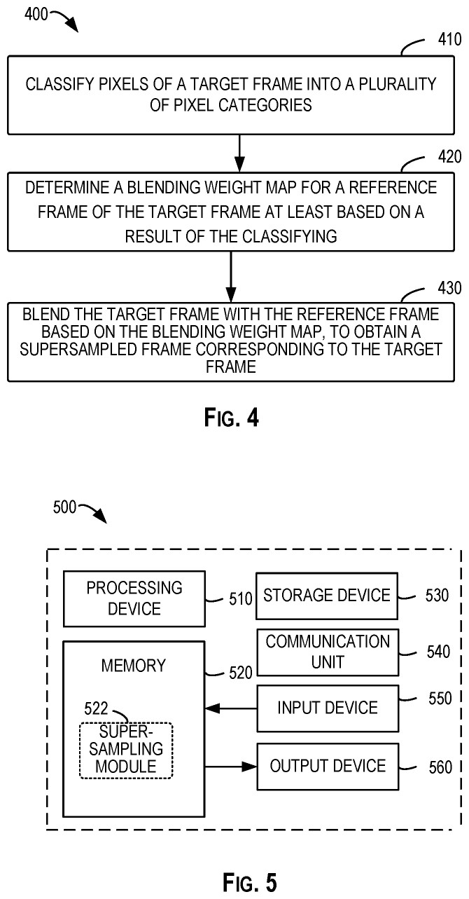

FIG. 4 illustrates a flow diagram of a process 400 for supersampling a frame in accordance with some implementations of the subject matter described herein. The process 400 may be implemented at the supersampling system 120 in FIG. 2 or FIG. 3.

At block 410, the supersampling system 120 classifies pixels of a target frame into a plurality of pixel categories.

At block 420, the supersampling system 120 determines a blending weight map for a reference frame of the target frame at least based on a result of the classifying, and the blending weight map indicates importance degrees of pixels of the reference frame in blending.

At block 440, the supersampling system 120 blends the target frame with the reference frame based on the blending weight map, to obtain a supersampled frame corresponding to the target frame.

In some implementations, determining the result of the classifying comprises determining the result of the classifying based on at least one of the following: depth information of the target frame, motion information of the target frame, or auxiliary information related to at least one historical frame.

In some implementations, determining the blending weight map comprises determining the blending weight map based on at least one of the following depth information of the target frame, motion information of the target frame, or auxiliary information related to at least one historical frame.

In some implementations, the auxiliary information indicates at least one of the following: for historical pixels of the at least one historical frame corresponding to target pixels of the target frame, the number of valid pixels among the historical pixels, a color change range of the valid pixels among the historical pixel and the target pixels, a depth difference between the target pixels and the historical pixels, or a classification result of the historical pixels in the plurality of pixel categories.

In some implementations, the plurality of pixel categories comprise at least one of the following: at least one pixel category related to aliasing pixels, or at least one pixel category related to ghosting pixels. In some implementations, the result of the classifying indicates at least one of the following: a probability that a pixel of the target frame belongs to the at least one pixel category related to the aliasing pixels, and a probability that a pixel of the target frame belongs to the at least one pixel category related to the ghosting pixels.

In some implementations, the at least one pixel category related to the aliasing pixels comprises at least: a geometry aliasing pixel category, a texture aliasing pixel category, and a non-aliasing pixel category. In some implementations, the at least one pixel category related to the ghosting pixels comprises at least: a visibility induced ghosting pixel category, a shadow ghosting pixel category, and a non-ghosting pixel category.

In some implementations, the pixels of the target frame are classified into a plurality of pixel categories using a classification model, and the blending weight map is determined based on the result of the classifying using a blending weight model.

In some implementations, training data for training the classification model and the blending weight model comprises at least a sample frame with a same resolution as the supersampled frame and labeling information for the sample frame, the labeling information indicating a classification result of pixels of the sample frame in the plurality of pixel categories and a blending weight map for the sample frame.

In some implementations, classifying the pixels of the target frame into the plurality of pixel categories comprises: upsampling the target frame to obtain an upsampled target frame with a same resolution as the supersampled frame; and classifying pixels of the upsampled target frame into the plurality of pixel categories.

In some implementations, the reference frame comprises a historical supersampled frame corresponding to a historical frame preceding the target frame.

FIG. 5 illustrates a schematic block diagram of an electronic device in which various implementations of the subject matter described herein can be implemented. It would be appreciated that the electronic device 500 as shown in FIG. 5 is merely provided as an example, without suggesting any limitation to the functionalities and scope of implementations of the subject matter described herein.

As shown in FIG. 5, the electronic device 500 is in form of a general-purpose computing device.

Components of the electronic device 500 may include, but are not limited to, one or more processors or processing devices 510, a memory 520, a storage device 530, one or more communication units 540, one or more input devices 550, and one or more output devices 560.

In some implementations, the electronic device 500 may be implemented as a device with computing capability, such as a computing device, a computing system, a server, a mainframe and so on.

The processing device 510 can be a physical or virtual processor and can execute various processing based on the programs stored in the memory 520. In a multi-processor system, a plurality of processing units execute computer-executable instructions in parallel so as to enhance parallel processing capability of the electronic device 500. The processing device 510 may include a central processing unit (CPU), a graphics processing unit (GPU), a microprocessor, a controller, and/or a microcontroller.

The electronic device 500 usually includes various computer storage media. Such media may be any available media accessible by the electronic device 500, including but not limited to, volatile and non-volatile media, or detachable and non-detachable media. The memory 520 may be a volatile memory (for example, a register, cache, Random Access Memory (RAM)), non-volatile memory (for example, a Read-Only Memory (ROM), Electrically Erasable Programmable Read-Only Memory (EEPROM), a flash memory), or any combination thereof. The storage device 530 may be any detachable or non-detachable medium and may include computer-readable medium such as a memory, a flash memory drive, a magnetic disk or any other media that can be used for storing information and/or data and are accessible by the electronic device 500.

The electronic device 500 may further include additional detachable/non-detachable, volatile/non-volatile memory media. Although not shown in FIG. 5, there may be provided a disk drive for reading from or writing into a detachable and non-volatile disk, and an optical disk drive for reading from and writing into a detachable non-volatile optical disc. In such cases, each drive may be connected to a bus (not shown) via one or more data medium interfaces.

The communication unit 540 implements communication with another computing device via the communication medium. In addition, the functionalities of components in the electronic device 500 may be implemented by a single computing cluster or a plurality of computing machines that can communicate with each other via communication connections. Thus, the electronic device 500 may operate in a networked environment using a logic connection with one or more other servers, network personal computers (PCs), or further general network nodes.

The input device 550 may include one or more of a variety of input devices, such as a mouse, keyboard, data import device and the like. The output device 560 may be one or more output devices, such as a display, data export device and the like. By means of the communication unit 540, the electronic device 500 may further communicate with one or more external devices (not shown) such as storage devices and display devices, one or more devices that enable the user to interact with the electronic device 500, or any devices (such as a network card, a modem and the like) that enable the electronic device 500 to communicate with one or more other computing devices, if required. Such communication may be performed via input/output (I/O) interfaces (not shown).

In some implementations, as an alternative of being integrated on a single device, some or all components of the electronic device 500 may also be arranged in the form of cloud computing architecture. In the cloud computing architecture, the components may be provided remotely and work together to implement the functionalities described in the subject matter described herein.

In some implementations, cloud computing provides computing, software, data access and storage service, which will not require end users to be aware of the physical locations or configurations of the systems or hardware provisioning these services. In various implementations, the cloud computing provides the services via a wide area network (such as Internet) using proper protocols. For example, a cloud computing provider provides applications over the wide area network, which may be accessed through a web browser or any other computing components. The software or components of the cloud computing architecture and corresponding data may be stored in a server at a remote position. The computing resources in the cloud computing environment may be aggregated or distributed at locations of remote data centers. Cloud computing infrastructure may provide the services through a shared data center, though they behave as a single access point for the users. Therefore, the cloud computing infrastructure may be utilized to provide the components and functionalities described herein from a service provider at remote locations. Alternatively, they may be provided from a conventional server or may be installed directly or otherwise on a client device.

The electronic device 500 may be used to implement resource management in accordance with various implementations of the subject matter described herein. The memory 520 may include one or more modules having one or more program instructions. These modules may be accessed and run by the processing unit 510 to perform functions of various implementations described herein. For example, the memory 520 may include a resource management module 522 for performing management of resources for a specific processing unit. As shown in FIG. 5, the electronic device 500 may obtain an input required for resource management through the input device 550 and provide an output of resource management through the output device 560. In some implementations, the electronic device 500 may further receive an input from other device (not shown) via the communication unit 540.

Some example implementations of the subject matter described herein are listed below.

In an aspect, the subject matter described herein provides a computer-implemented method. The method comprises: classifying pixels of a target frame into a plurality of pixel categories; determining a blending weight map for a reference frame of the target frame at least based on a result of the classifying, the blending weight map indicating importance degrees of pixels of the reference frame in blending; and blending the target frame with the reference frame based on the blending weight map, to obtain a supersampled frame corresponding to the target frame.

In some example implementations, determining the result of the classifying comprises determining the result of the classifying based on at least one of the following: depth information of the target frame, motion information of the target frame, or auxiliary information related to at least one historical frame.

In some example implementations, determining the blending weight map comprises determining the blending weight map based on at least one of the following: depth information of the target frame, motion information of the target frame, or auxiliary information related to at least one historical frame.

In some example implementations, the auxiliary information indicates at least one of the following: for historical pixels of the at least one historical frame corresponding to target pixels of the target frame, the number of valid pixels among the historical pixels, a color change range of the valid pixels among the historical pixels and the target pixels, a depth difference between the target pixels and the historical pixels, or a classification result of the historical pixels in the plurality of pixel categories.

In some example implementations, the plurality of pixel categories comprise at least one of the following: at least one pixel category related to aliasing pixels, or at least one pixel category related to ghosting pixels. In some example implementations, the result of the classifying indicates at least one of the following: a probability that a pixel of the target frame belongs to the at least one pixel category related to the aliasing pixels, and a probability that a pixel of the target frame belongs to the at least one pixel category related to the ghosting pixels.

In some example implementations, the at least one pixel category related to the aliasing pixels comprises at least: a geometry aliasing pixel category, a texture aliasing pixel category, and a non-aliasing pixel category. In some example implementations, the at least one pixel category related to the ghosting pixels comprises at least: a visibility induced ghosting pixel category, a shadow ghosting pixel category, and a non-ghosting pixel category.

In some example implementations, the pixels of the target frame are classified into the plurality of pixel categories using a classification model, and the blending weight map is determined based on the result of the classifying using a blending weight model.

In some example implementations, training data for training the classification model and the blending weight model comprises at least a sample frame with a same resolution as the supersampled frame and labeling information for the sample frame, the labeling information indicating a classification result of pixels of the sample frame in the plurality of pixel categories and a blending weight map for the sample frame.

In some example implementations, classifying the pixels of the target frame into the plurality of pixel categories comprises: upsampling the target frame to obtain an upsampled target frame with a same resolution as the supersampled frame; and classifying pixels of the upsampled target frame into the plurality of pixel categories.

In some example implementations, the reference frame comprises a historical supersampled frame corresponding to a historical frame preceding the target frame.

In another aspect, the subject matter described herein provides an electronic device. The electronic device comprises a processor; and a memory coupled to the processor and comprising instructions stored thereon which, when executed by the processor, cause the device to perform acts comprising: classifying pixels of a target frame into a plurality of pixel categories; determining a blending weight map for a reference frame of the target frame at least based on a result of the classifying, the blending weight map indicating importance degrees of pixels of the reference frame in blending; and blending the target frame with the reference frame based on the blending weight map, to obtain a supersampled frame corresponding to the target frame.

In some example implementations, determining the result of the classifying comprises determining the result of the classifying based on at least one of the following: depth information of the target frame, motion information of the target frame, or auxiliary information related to at least one historical frame.

In some example implementations, determining the blending weight map comprises determining the blending weight map based on at least one of the following or depth information of the target frame, motion information of the target frame, and auxiliary information related to at least one historical frame.

In some example implementations, the auxiliary information indicates at least one of the following: for historical pixels of the at least one historical frame corresponding to target pixels of the target frame, the number of valid pixels among the historical pixel, a color change range of the valid pixels among the historical pixel and the target pixels, a depth difference between the target pixels and the historical pixels, or a classification result of the historical pixels in the plurality of pixel categories.

In some example implementations, the plurality of pixel categories comprise at least one of the following: at least one pixel category related to aliasing pixels, or at least one pixel category related to ghosting pixels. In some example implementations, the classification result indicates at least one of the following: a probability that a pixel of the target frame belongs to the at least one pixel category related to the aliasing pixels, and a probability that a pixel of the target frame belongs to the at least one pixel category related to the ghosting pixels.

In some example implementations, the at least one pixel category related to the aliasing pixels comprises at least: a geometry aliasing pixel category, a texture aliasing pixel category, and a non-aliasing pixel category. In some example implementations, the at least one pixel category related to the ghosting pixel comprises at least: a visibility induced ghosting pixel category, a shadow ghosting pixel category, and a non-ghosting pixel category.

In some example implementations, the pixels of the target frame are classified into the plurality of pixel categories using a classification model, and the blending weight map is determined based on the result of the classifying using a blending weight model.

In some example implementations, training data for training the classification model and the blending weight model comprises at least a sample frame with a same resolution as the supersampled frame and labeling information for the sample frame, the labeling information indicating a classification result of pixels of the sample frame in the plurality of pixel categories and a blending weight map for the sample frame.

In some example implementations, classifying the pixels of the target frame into the plurality of pixel categories comprises: upsampling the target frame to obtain an upsampled target frame with a same resolution as the supersampled frame; and classifying pixels of the upsampled target frame into the plurality of pixel categories.

In some example implementations, the reference frame comprises a historical supersampled frame corresponding to a historical frame preceding the target frame.

In yet another aspect, the subject matter described herein provides a computer program product that is tangibly stored in a computer storage medium and comprises computer executable instructions that, when executed by a device, cause the device to perform acts comprising: classifying pixels of a target frame into a plurality of pixel categories; determining a blending weight map for a reference frame of the target frame at least based on a result of the classifying, the blending weight map indicating importance degrees of pixels of the reference frame in blending; and blending the target frame with the reference frame based on the blending weight map, to obtain a supersampled frame corresponding to the target frame.

In some example implementations, determining the result of the classifying comprises determining the result of the classifying based on at least one of the following: depth information of the target frame, motion information of the target frame, or auxiliary information related to at least one historical frame.

In some example implementations, determining the blending weight map comprises determining the blending weight map based on at least one of the following: depth information of the target frame, motion information of the target frame, or auxiliary information related to at least one historical frame.

In some example implementations, the auxiliary information indicates at least one of the following: for historical pixels of the at least one historical frame corresponding to target pixels of the target frame, the number of valid pixels among the historical pixels, a color change range of the valid pixels among the historical pixel and the target pixels, a depth difference between the target pixels and the historical pixels, or a classification result of the historical pixel in the plurality of pixel categories.

In some example implementations, the plurality of pixel categories comprise at least one of the following: at least one pixel category related to aliasing pixels, or at least one pixel category related to ghosting pixels. In some example implementations, the classification result indicates at least one of a probability that a pixel of the target frame belongs to the at least one pixel category related to aliasing pixels, and a probability that a pixel of the target frame belongs to the at least one pixel category related to ghosting pixel.

In some example implementations, the at least one pixel category related to the aliasing pixels comprises at least a geometry aliasing pixel category, a texture aliasing pixel category, and a non-aliasing pixel category. In some example implementations, the at least one pixel category related to the ghosting pixels comprises at least a visibility induced ghosting pixel category, a shadow ghosting pixel category, and a non-ghosting pixel category.

In some example implementations, the pixels of the target frame are classified into the plurality of pixel categories using a classification model, and the blending weight map is determined based on the result of the classifying using a blending weight model.

In some example implementations, training data for training the classification model and the blending weight model comprises at least a sample frame with a same resolution as the supersampled frame and labeling information for the sample frame, the labeling information indicating a classification result of pixels of the sample frame in the plurality of pixel categories and a blending weight map for the sample frame.

In some example implementations, classifying the pixels of the target frame into the plurality of pixel categories comprises upsampling the target frame to obtain an upsampled frame with a same resolution as the supersampled frame; and classifying pixels of the upsampled target frame into the plurality of pixel categories.

In some example implementations, the reference frame comprises a historical supersampled frame corresponding to a historical frame preceding the target frame.

In yet another aspect, the subject matter described herein provides a computer-readable medium having computer executable instructions stored thereon that, when executed by a device, cause the device to perform one or more example implementations of the methods of the above aspects.

The functionalities described herein can be performed, at least in part, by one or more hardware logic components. As an example, and without limitation, illustrative types of hardware logic components that can be used include field-programmable gate arrays (FPGAs), Application-specific Integrated Circuits (ASICs), application-specific standard products (ASSPs), system-on-a-chip systems (SOCs), complex programmable logic devices (CPLDs), and the like.

Program code for carrying out the methods of the subject matter described herein may be written in any combination of one or more programming languages. The program code may be provided to a processor or controller of a general-purpose computer, special purpose computer, or other programmable data processing flowchart such that the program code, when executed by the processor or controller, causes the functions/operations specified in the flowcharts and/or block diagrams to be implemented. The program code may be executed entirely or partly on a machine, executed as a stand-alone software package partly on the machine, partly on a remote machine, or entirely on the remote machine or server.

In the context of this disclosure, a machine-readable medium may be any tangible medium that may contain or store a program for use by or in connection with an instruction execution system, flowchart, or device. The machine-readable medium may be a machine-readable signal medium or a machine-readable storage medium. A machine-readable medium may include but is not limited to an electronic, magnetic, optical, electromagnetic, infrared, or semiconductor system, flowchart, or device, or any suitable combination of the foregoing. More specific examples of the machine-readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations are performed in the particular order shown or in sequential order, or that all illustrated operations are performed to achieve the desired results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular implementations. Certain features that are described in the context of separate implementations may also be implemented in combination in a single implementation. Rather, various features described in a single implementation may also be implemented in multiple implementations separately or in any suitable sub-combination.

Although the subject matter has been described in language specific to structural features and/or methodological acts, it is to be understood that the subject matter specified in the appended claims is not necessarily limited to the specific features or acts described above. Rather, the specific features and acts described above are disclosed as example forms of implementing the claims.

1. A computer-implemented method, comprising:
classifying pixels of a target frame into a plurality of pixel categories;
determining a blending weight map for a reference frame of the target frame at least based on a result of the classifying, the blending weight map indicating importance degrees of pixels of the reference frame in blending; and
blending the target frame with the reference frame based on the blending weight map, to obtain a supersampled frame corresponding to the target frame.

2. The method of claim 1, wherein determining the result of the classifying comprises determining the result of the classifying based on at least one of the following:
depth information of the target frame,
motion information of the target frame, or
auxiliary information related to at least one historical frame.

3. The method of claim 1, wherein determining the blending weight map comprises determining the blending weight map further based on at least one of the following:
depth information of the target frame,
motion information of the target frame, or
auxiliary information related to at least one historical frame.

4. The method of claim 2, wherein the auxiliary information indicates at least one of the following: for historical pixels of the at least one historical frame corresponding to target pixels of the target frame,
the number of valid pixels among the historical pixels,
a color change range of the valid pixels among the historical pixels and the target pixels,
a depth difference between the target pixels and the historical pixels, or
a classification result of the historical pixels in the plurality of pixel categories.

5. The method of claim 1, wherein the plurality of pixel categories comprise at least one of the following: at least one pixel category related to aliasing pixels or at least one pixel category related to ghosting pixels; and
wherein the result of the classifying indicates at least one of the following: a probability that a pixel of the target frame belongs to the at least one pixel category related to the aliasing pixels, and a probability that a pixel of the target frame belongs to the at least one pixel category related to the ghosting pixels.

6. The method of claim 5, wherein the at least one pixel category related to the aliasing pixels comprises at least: a geometry aliasing pixel category, a texture aliasing pixel category, and a non-aliasing pixel category, and/or
wherein the at least one pixel category related to the ghosting pixels comprises at least: a visibility induced ghosting pixel category, a shadow ghosting pixel category, and a non-ghosting pixel category.

7. The method of claim 1, wherein the pixels of the target frame are classified into the plurality of pixel categories using a classification model, and the blending weight map is determined based on the result of the classifying using a blending weight model.

8. The method of claim 7, wherein training data for training the classification model and the blending weight model comprises at least a sample frame with a same resolution as the supersampled frame and labeling information for the sample frame, the labeling information indicating a classification result of pixels of the sample frame in the plurality of pixel categories and a blending weight map for the sample frame.

9. The method of claim 1, wherein classifying the pixels of the target frame into the plurality of pixel categories comprises:
upsampling the target frame to obtain an upsampled target frame with a same resolution as the supersampled frame; and
classifying pixels of the upsampled target frame into the plurality of pixel categories.

10. The method of claim 1, wherein the reference frame comprises a historical supersampled frame corresponding to a historical frame preceding the target frame.

11. An electronic device comprising:
a processor; and
a memory coupled to the processor and comprising instructions stored thereon which, when executed by the processor, cause the device to perform acts comprising:
classifying pixels of a target frame into a plurality of pixel categories;
determining a blending weight map for a reference frame of the target frame at least based on a result of the classifying, the blending weight map indicating importance degrees of pixels of the reference frame in blending; and
blending the target frame with the reference frame based on the blending weight map, to obtain a supersampled frame corresponding to the target frame.

12. The device of claim 11, wherein determining the result of the classifying comprises determining the result of the classifying based on at least one of the following:
depth information of the target frame,
motion information of the target frame, or
auxiliary information related to at least one historical frame.

13. The device of claim 11, wherein determining the blending weight map comprises determining the blending weight map further based on at least one of the following:
depth information of the target frame,
motion information of the target frame,
auxiliary information related to at least one historical frame.

14. The device of claim 12, wherein the auxiliary information indicates at least one of the following: for historical pixels of the at least one historical frame corresponding to target pixels of the target frame,
the number of valid pixels among the historical pixels,
a color change range of the valid pixel among the historical pixels and the target pixels,
a depth difference between the target pixels and the historical pixels, or
a classification result of the historical pixels in the plurality of pixel categories.

15. A computer program product being tangibly stored in a computer storage medium and comprising computer executable instructions that, when executed by a device, cause the device to perform acts comprising:
classifying pixels of a target frame into a plurality of pixel categories;
determining a blending weight map for a reference frame of the target frame at least based on a result of the classifying, the blending weight map indicating importance degrees of pixels of the reference frame in blending; and
blending the target frame with the reference frame based on the blending weight map, to obtain a supersampled frame corresponding to the target frame.
